(19) United States
(12) Patent Application Publication
(10) Pub. No.: US 2016/0027317 A1
(43) Pub. Date: Jan. 28, 2016

(54) VOCAL PRACTIC AND VOICE PRACTIC SYSTEM

(71) Applicant: Seung Woo LEE, Seoul (KR)

(72) Inventor: Seung Woo LEE, Seoul (KR)

(21) Appl. No.: 14/445,027

(22) Filed: Jul. 28, 2014

(51) Int. Cl. G09B 5/06; G09B 15/00; G09B 19/04

(52) U.S. Cl. CPC G09B 5/06; G09B 19/04; G09B 15/00

(57) ABSTRACT

A vocal practic and voice practic system comprises a storage unit configured to store a reference waveform that is generated based on a trainer's period vocal sound during a predetermined sampling period, a recording unit configured to record a trainee's period vocal sound that is generated as the trainee sings or recites during the predetermined sampling period, a waveform converting unit configured to convert the trainee's period vocal sound into an initial period waveform, a waveform analyzing unit configured to extract the reference waveform from the storage unit and to compare the extracted reference waveform with the initial period waveform, and a display unit configured to display the extracted reference waveform and the initial period waveform.

### TECHNICAL FIELD

Exemplary embodiments of the present invention relate to is vocal practic and voice practic system, and more specifically, to a vocal practic and voice practic system that allows for systematic vocal training by providing imaged results.

### DISCUSSION OF RELATED ART

Conventional vocal training or correction primarily relies on human vocal trainers and thus cannot show a uniform result to all the persons that desire better vocal skills. Moreover, the conventional methods are difficult to apply to general vocalization other than singing. Thus, a need exists for a systematic vocal practic and voice practic system or method that may allow all the vocal trainees to have an even achievement and that may be applicable to normal vocalization as well as singing.

### SUMMARY

According to an exemplary embodiment of the present invention, a vocal practic and voice practic system comprises a storage unit configured to store a reference waveform that is generated based on a trainer's period vocal sound during a predeterinined sampling period, a recording unit configured to record a trainee's period vocal sound that is generated as the trainee sings or recites during the predetermined sampling period, a waveform converting unit configured to convert the trainee's period vocal sound into an initial period waveform, a waveform analyzing unit configured to extract the reference waveform from the storage unit and to compare the extracted reference waveform with the initial period waveform, and a display unit configured to display the extracted reference waveform and the initial period waveform.

The recording unit is configured to record the trainee's additional vocal sound during the sampling period while an exercise on a training area prepared for the trainee is performed or at a plurality of times when the exercise is complete, the waveform converting unit is configured to convert the recorded additional vocal sound into an additional period waveform, the waveform analyzing unit is configured to compare the additional period waveform with the initial period waveform and the reference waveform, and the display unit is configured to display a result of the comparison, so that the trainee may visually recognize a degree of correction and whether the trainee's vocal is corrected.

The training area includes one or more of a vocal cord vibration training area, a resonance training area, a rhythm training area, a voice training area, and a breathing/vocalizing training area.

The waveform analyzing unit is configured to display through the display unit a consistency ratio for each training area when comparing the initial period waveform with the reference waveform or comparing the additional period waveform with the reference waveform.

The waveform analyzing unit is configured to generate a schedule per training area depending on the consistency ratio and to display the generated schedule through the display unit.

A training method by the vocal cord vibration training area includes one or more of a relax deep breath training method, an avo lips trill training method, a from vocal cords training method, an elastic utilize training method, a rebound training method, an Adam's apple training method, a grip training method, an outside muscle training method, an acceleration training method, a natural tone training method, a whisper training method, an elastic condition training method, a natural song training method, a whisper song training method, a rubber ball timing training method, and a balance togu training method.

A training method by the resonance training area includes one or more of a nasal cavity low training method, a nasal cavity middle training method, as nasal cavity high training method, a natural dream training method, a NING NING training method, a nasal cavity condition training method, a natural philtrum training method, a philtrum and dream training method, a nasal cavity activation training method, a nasal cavity scale hindrance muscle training method, a pharynx scale hindrance muscle training method, a pharynx falsetto training method, a real voice and head voice training method, and a and for training method.

A training method by the resonance training area includes one or more of a running 1-2 training method, a running song training method, a walk 1-2 training method, a walk song training method, a gesture groove training method, a groove sense training method, a play hard to get training method, a relax long tone training method, and an relax attack training method.

A training method by the voice training area includes one or more of a practic tongue training method, a practic jaw training method, a practic facial muscle training method, a practic facial outside muscle training method, a head move training method, a vibration apply song training method, a natural tone training method, a practic abdomen pressure training method, a no breathing start training method, a pitch training method, a low-high pitch training method, an apple pitch training method, a schoolbook expression training method, a narration expression training method, a musical between original training method, a musical expression training method, an original expression training method, and a ah resonator training method.

A training method by the breathing/vocalizing training area includes one or more of an erase mimic training method, a castle gate training method, a dog breath training method, a dog breath song training method, a top of a mountain training method, a pull chest voice training method, a pull head voice training area, and a baby attack training method.

According to an exemplary embodiment of the present invention, a vocal practic and voice practic system comprises a storage unit configured to store a reference waveform that is generated based on a first person's period vocal sound during a predetermined sampling period, a recording unit configured to record as second person's period vocal sound that is generated as the second person sings or recites during the predetermined sampling period, a waveform converting unit configured to convert the second person's period vocal sound into an initial period waveform, a waveform analyzing unit configured to extract the reference waveform from the storage unit and to compare the extracted reference waveform with the initial period waveform, and a display unit configured to display the extracted reference waveform and the initial period waveform, in which the recording, unit is configured to record the second person's additional vocal sound during the sampling period while an exercise on training areas prepared for the second person is performed or at a plurality of times when the exercise is complete.

The waveform converting unit is configured to convert the recorded additional vocal sound into an additional period waveform, the waveform analyzing unit is configured to compare the additional period waveform with the initial period waveform and the reference waveform, and the display unit is configured to display a result of the comparison, so that the second person may visually recognize a degree of correction and whether the second person's vocal is corrected.

The training areas are stored in a memory and is processed by a computer-readable processor. The training areas include one or more of a vocal cord vibration training area, a resonance training area, a rhythm training area, a voice training area, and a breathing/vocalizing training area.

The waveform analyzing unit is configured to display through the display unit a consistency ratio for each training area when comparing the initial period waveform with the reference waveform or comparing the additional period waveform with the reference waveform.

The waveform analyzing unit is configured to generate a schedule per training area depending on the consistency ratio and to display the generated schedule through the display unit.

A training method by the vocal cord vibration training area includes one or more of a relax deep breath training method, an avo lips trill training method, a from vocal cords training method, an elastic utilize training method, a rebound training method, an Adam's apple training method, a grip training method, an outside muscle training method, an acceleration training method, a natural tone training method, a whisper training method, an elastic condition training method, a natural song training method, a whisper song training method, a rubber ball timing training method, and a balance togu training method.

A training method by the resonance training area includes one or more of a nasal cavity low training method, a nasal cavity middle training method, a nasal cavity high training method, a natural dream training method, a NING NING training method, a nasal cavity condition training method, a natural philtrum training method, a philtrum and dream training method, a nasal cavity activation training method, a nasal cavity scale hindrance muscle training method, a pharynx scale hindrance muscle training method, a pharynx falsetto training method, a real voice and head voice training method, and a and for training method.

A training method by the resonance training area includes one or more of a running 1-2 training method, a running song training method, a walk 1-2 training method, a walk song training method, a gesture groove training method, a groove sense training method, a play hard to get training method, a relax long tone training method, and an relax attack training method.

A training method by the voice training area includes one or more of a practic tongue training method, a practic jaw training method, a practic facial muscle training method, a practic facial outside muscle training method, a head move training method, a vibration apply song training method, a natural tone training method, a practic abdomen pressure training method, a no breathing start training method, a pitch training method, a low-high pitch training method, an apple pitch training method, a schoolbook expression training method, a narration expression training method, a musical between original training method, a musical expression training method, an original expression training method, and a ah resonator training method.

### BRIEF DESCRIPTION OF DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view illustrating a configuration of a vocal practic and voice practic system according to an exemplary embodiment of the present invention;

FIG. 2 is a view illustrating waveforms displayed by a waveform analyzing unit of a vocal practic and voice practic system according to an exemplary embodiment of the present invention;

FIG. 3 is a view illustrating a comparison between an initial period waveform, a reference waveform, and an additional period waveform as displayed by a waveform analyzing unit of a vocal practic and voice practic system according to an exemplary embodiment of the present invention; and

FIG. 4 is a view illustrating a comparison between an initial period waveform and an additional period waveform as displayed by a waveform analyzing unit of a vocal practic and voice practic system according to an exemplary embodiment of the present invention.

### DETAILED DESCRIPTION OF EXEMPLARY EMBODIMENTS

Hereinafter, exemplary embodiments of the inventive concept will be described in detail with reference to the accompanying drawings. The inventive concept, however, may be modified in various different ways, and should not be construed as limited to the exemplary embodiments set forth herein.

As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be dircectly on, connected, coupled, or adjacent to the other element or layer, or intervening elements or layers may be present.

Unless otherwise defined, all terms including technical and scientific terms used herein have the same meaning as commonly understood by one of ordinary skill in the art to which the exemplary embodiments of the present disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “practice” may mean or include, but is limited to, vocal treatment, vocal correction, practicing or exercising vocalization, etc.

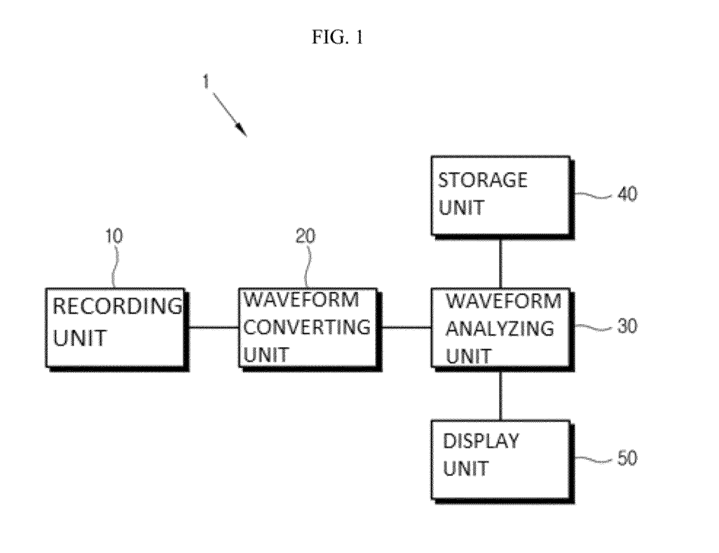

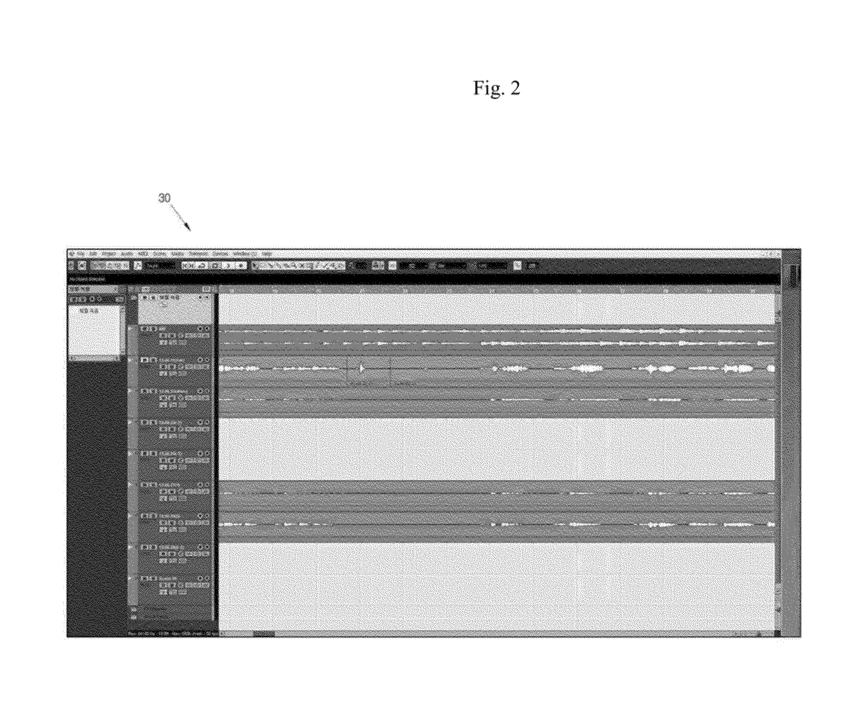

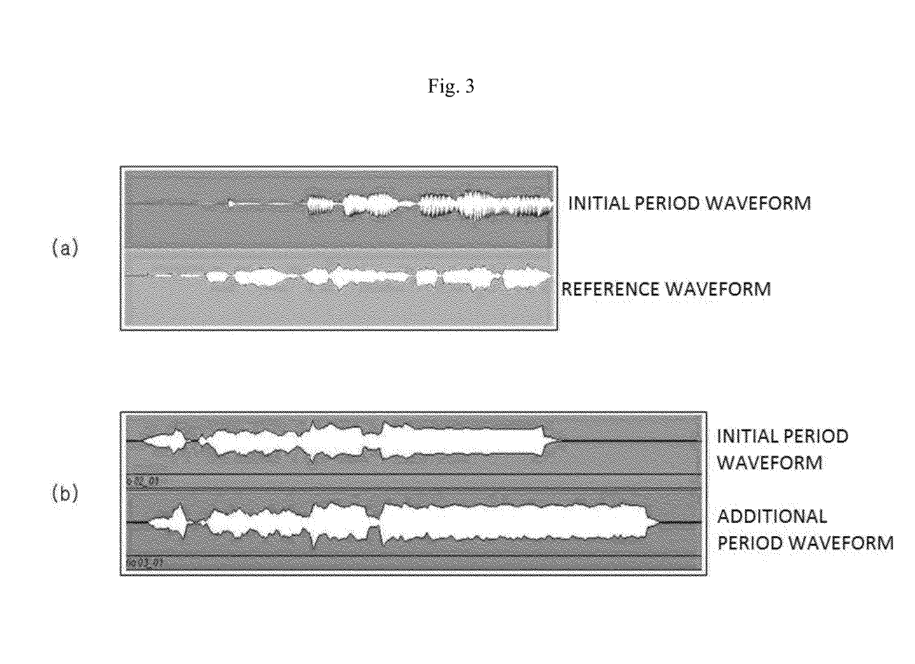

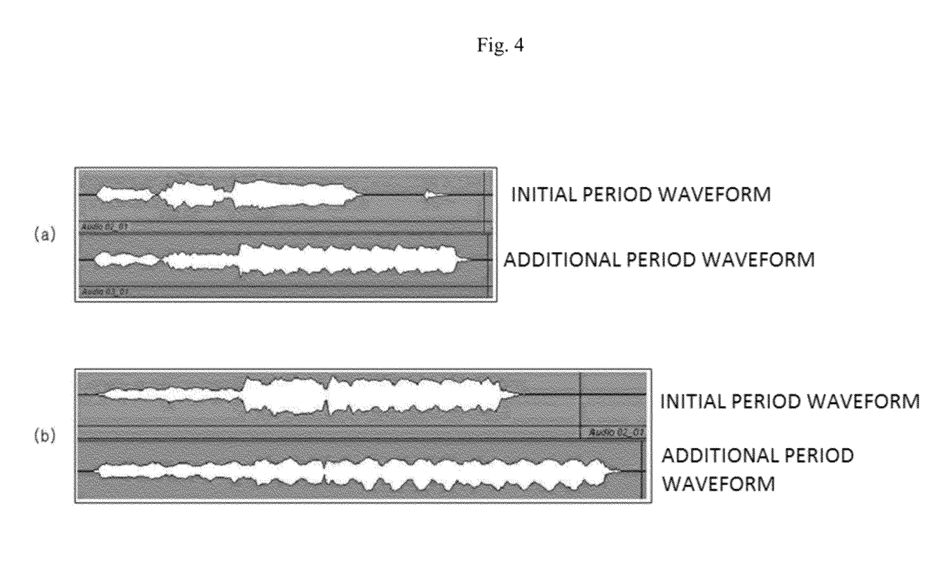

FIG. 1 is a view illustrating a configuration of a vocal practic and voice practic system according to an exemplary embodiment of the present invention. FIG. 2 is a view illustrating waveforms displayed by a waveform analyzing unit of a vocal practic and voice practic system according to an exemplary embodiment of the present invention. FIG. 3 is a view illustrating a comparison between an initial period waveform, a reference waveform, and an additional period waveform as displayed by a waveform analyzing unit of a vocal practic and voice practic system according to an exemplary embodiment of the present invention. FIG. 4 is a view illustrating a comparison between an initial period waveform and an additional period waveform as displayed by a waveform analyzing unit of a vocal practic and voice practic system according to an exemplary embodiment of the present invention.

Referring to FIG. 1, according to an exemplary embodiment of the present invention, a vocal practic and voice practic system 1 includes a storage unit 40 configured to store a reference waveform that is generated based on a trainer's period vocal sound during a predetermined sampling period, a recording unit 10 configured to record a trainee's period vocal sound that is generated as the trainee sings or recites during the predetermined sampling period, a waveform converting unit 20 configured to convert the trainee's period vocal sound into an initial period waveform, a waveform analyzing unit 30 configured to extract the reference waveform from the storage unit 40 and to compare the extracted reference waveform with the initial period waveform, and a display unit 50 configured to display the extracted reference waveform and the initial period waveform.

According to an exemplary embodiment of the present invention, the recording unit 10 is configured to record the trainee's additional vocal sound during the sampling period while an exercise on training areas prepared for the trainee is performed or at a plurality of times when the exercise is complete, the waveform converting unit 20 is configured to convert the recorded additional vocal sound into an additional period waveform, the waveform analyzing unit 30 is configured to compare the additional period waveform with the initial period waveform and the reference waveform, and the display unit 50 is configured to display a result of the comparison, so that the trainee may visually recognize a degree of correction and whether the trainee's vocal is corrected.

The sampling period is a time period for appreciating the trainee's vocal state and estimating the degree of vocal correction. For example, the sampling period may include, but not limited to, a measure of a song or a sentence. Various sampling periods may be provided according to each item to be corrected (e.g., vibration, pitch, or echo), for allowing a to-be-corrected item to be properly appreciated.

The recording unit 10 may include a microphone and a recording software program for recording a voice or other sounds.

The waveform converting unit 20 converts the recorded period vocal sound into a waveform and displays the waveform, e.g., through the display unit 50. The waveform converting unit 20 converts a newly recorded period vocal sound into an additional period waveform while vocal correction is being performed or complete.

The waveform analyzing unit 30 may display a consistency ratio per training area when comparing the initial period waveform with the reference waveform or when comparing the additional period waveform with the reference waveform. For example, the waveform analyzing unit 30 may represent the length, frequency, and amplitude of the reference waveform as numerical values and may generate or output numerical values corresponding to differences between the reference waveform and the additional period waveform in view of, e.g., the length, frequency, and amplitude of the waveforms. Accordingly, the trainee may visually or numerically identify the degree of correction.

In such case, the waveform analyzing unit 30 may generate a schedule based on the order of correction per training area depending on the consistency ratio.

For example, the waveform analyzing unit 30 may configure an item for which the consistency ratio is to be analyzed, for each training area, and may the generate and provide a correction schedule in which the training areas are to be practiced in ascending order from the lowest consistency ratio.

The training areas may be stored in a memory (not shown) and may be processed by a computer-readable processor (not shown).

Here, the training area may include one or more of a vocal cord vibration training area, a resonance training area, a rhythm training area, a voice training area, and a breathing/vocalizing training area.

Hereinafter, the above-listed training areas are described in greater detail.

Vocal Cord Vibration Training Area

A vocal correction method by the vocal cord vibration training area includes a relax deep breath training method, an avo lips trill training method, a from vocal cords training method, an elastic utilize training method, a rebound training method, an Adam's apple training method, a grip training method, an outside muscle training method, an acceleration training method, a natural tone training method, a whisper training method, an elastic condition training method, a natural song training method, a whisper song training method, a rubber ball timing training method, and a balance togu training method.

The above-listed training methods are now described one by one.

By the relax deep breath training method, the trainee is trained to allow the diaphragm to create a proper air pressure through air pressure training on the diaphragm. By doing so, the trainee's breath and vocal sound may last long. For example, the trainee is trained to maximally extend his breath while saying ‘tsu-,’ with his head slightly down.

By the avo lips trill training method, the trainee is trained to make the connection between his speaking tone and a sound natural. For example, the trainee is trained to vibrate his lips with both hands put on both chicks while saying, both ‘ah’ and ‘boo.’

The from vocal cords training method allows the vocal cords to be repeatedly exercised so that the vocal cords may stay elastic while making better the length of vocal sound or the closure of the vocal cords. For example, the trainee is trained to say ‘ah’ in such a manner as if he flicks a rubber ball to create a vibration.

The elastic utilize training method allows the state of utilization of the vocal cords to be known through a check on the utilization of elasticity of the vocal cords. For example, the trainee is trained to check the utilization of vocal cords, e.g., whether saying ‘ah’ lasts long.

The rebound training method allows the trainee to be able to keep the length of vocal sound longer with a smaller amount of breath using the elastic bounce of vocal cords. For example, the trainee is trained to say ‘ah’ using a bounce with a minimal amount of breath, thus creating a vibration.

The Adam's apple training method may mitigate the problems, such as the outside muscles of the vocal cords being strained or vocal sound being distorted when vibration is created, by making the larynx positioned better. For example, the trainee is trained to say ‘ah’ while drawing forwards a virtual horizontal line, with his finger resting on the Adam's apple.

The grip training method allows the closed state upon vibration to be checked, thus checking and enhancing the position where the vocal cords are not closed well. For example, the trainee is trained to check the closed state of the glottis of the vocal cords while saying ‘ah’ with vibration.

The outside muscle training method allows the muscles to be interfered upon vibration to be known by measuring the degree of intervention of other muscles upon vibration. For example, the trainee is trained to measure the degree of intervention of other muscles while saying ‘ah’ with vibration.

The acceleration training method allows the vocal sound to last longer with a small amount of breath by creating more bounce using the acceleration of the vibration. For example, the trainee is trained to increase the acceleration of vibration by suddenly increasing the speed of saying ‘ah’ with vibration.

The natural tone training method allows the trainee's natural tone to be maintained by enabling the trainee to discover the normal tone in which the trainee speaks normally and unconsciously and to apply the discovered tone to singing or speaking. For example, the trainee is trained to apply his voice tone in which he talks on the phone to saying ‘ah’ with vibration.

The whisper training method allows the trainee's natural whispering tone to be maintained by enabling the trainee to discover his natural voice tone in which he whispers normal and unconsciously and to apply the discovered tone to singing or speaking. For example, the trainee is trained to apply the voice tone in which he whispers on the phone to saying ‘ah’ with vibration.

The elastic condition training method allows it to be measured how further the elasticity of vocal cords should be increased by checking the elastic condition of the vocal cords. For example, the trainee is trained to measure the elastic condition of the vocal cords through the speed of vibration.

The natural song training method allows the trainee's natural speaking tone to be applied to singing song. For example, the trainee is trained to apply the vibrational state of his speaking tone to singing song.

The whisper song training method allows the trainee's natural whispering song to be applied to singing song. For example, the trainee is trained to apply the vibrational state of the trainee's whispering tone to singing song.

The rubber ball timing training method allows the utilization of elasticity to be imaged by imaging the vocal cords as a rubber ball and making the timing when the rubber ball reaching the ground is consistent with the timing when elasticity is provided. For example, the trainee is trained to provide elasticity when the bounced rubber ball gets to the ground while saying ‘ah’ with vibration.

The balance togu training method allows the trainee's belly to be not strained or stressed by distracting the trainee to balance his body when practicing vibration on the togu. For example, the trainee is trained to say ‘ah’ with vibration on the tool called ‘togu.’

Resonance Training Area

The training method by the resonance training area includes a nasal cavity low training method, a nasal cavity middle training method, a nasal cavity high training method, a natural dream training method, a NING NING training method, a nasal cavity condition training method, a natural philtrum training method, a philtrum and dream training method, a nasal cavity activation training method, a nasal cavity scale hindrance muscle training method, a pharynx scale hindrance muscle training method, a pharynx falsetto training method, a real voice and head voice training method, and a and for training method.

The above mentioned training methods are described in greater detail.

The nasal cavity low training method allows for creation of a low-tone nasal cavity resonance through a nasal cavity resonance training low tone. For example, the trainee is trained to say ‘DREAM’ at low tone through the resonance cavity positioned at the maxillary sinus.

The nasal cavity middle training method allows for creation of a middle-tone nasal cavity resonance through a nasal cavity resonance training middle tone. For example, the trainee is trained to say ‘DREAM’ at middle one through the resonance cavity positioned at the maxillary sinus.

The nasal cavity high training method allows for creation of a high-tone nasal cavity resonance through a nasal cavity resonance training high tone. For example, the trainee is trained to say ‘DREAM’ at high tone through the resonance cavity positioned at the maxillary sinus.

The natural dream training method allows for creation of a nasal cavity sound at a speaking tone. For example, the trainee is trained to say ‘DREAM’ at a speaking tone through the maxillary sinus to create resonance.

The NING NING training method allows the precise position of the nasal cavity to be known through its training. For example, the trainee is trained to create resonance at the maxillary sinus by saying ‘NING NING.’

The nasal cavity condition training method allows for guidance to the precise position of resonance in the nasal cavity by utilizing the facial expression and muscles and checking the opened condition of the nasal cavity. For example, the trainee is trained to use his facial muscles and check the opened condition of the nasal cavity through, e.g., a mirror, upon nasal cavity resonance.

The natural philtrum training method allows for indication of the position where resonance occurs at a front side of his nose through an imaged philtrum sound. For example, the trainee is trained to create resonance by saying ‘eum’ at the position of the philtrum.

The philtrum and dream training method allows for forward shift of the position where a nasal cavity sound is felt by training philtrum resonance and nasal cavity resonance. For example, the trainee is trained to create resonance by saying ‘eum’ at the position of the philtrum while simultaneously saying ‘DREAM’ to vibrate the maxillary sinus.

The nasal cavity activation training method allows for 100% utilization of the nasal cavity by checking the degree of activation of the nasal cavity. For example, the trainee is trained to create resonance by saying ‘DREAM’ in higher voice tone.

The nasal cavity scale hindrance muscle training method allows for a check on whether there are hindrance muscles outside the larynx through nasal cavity scale training. For example, the trainee is trained to say ‘DREAM’ in higher voice tone through piano scaling.

Pharynx scale hindrance muscle training method allows for a check on whether there are hindrance muscles outside the larynx through pharyngeal cavity scale training. For example, the trainee is trained to create resonance by saying ‘erh’ by holding the position of the pharyngeal cavity to the rear along the diagonal line, with the third finger of a hand opened except the other fingers resting between the upper and lower teeth.

The pharynx falsetto training method allows for generation of a head voice by creating resonance with a falsetto at the position of the pharyngeal cavity. For example, the trainee is trained to create resonance at a falsetto while holding the position of the pharyngeal cavity to the rear along the diagonal line, with a third finger opened except the other fingers resting between the upper and lower teeth.

The real voice and head voice training method allows for distinct production between a real voice and a head voice and smooth and the natural passage of passaggio. For example, the trainee is trained to create resonance from real sound to head sound while holding the position of the pharyngeal cavity to the rear along the diagonal line, with the third finger of a hand opened except the other fingers resting between the upper and lower teeth.

The and for training method allows for discovery of the position where the glottis of the vocal cords fails to close and the closure of the glottis. For example, the trainee is trained to keep on saying ‘And for’ at the position where the glottis does not close.

Rhythm Training Area

The training method by the rhythm training area includes a running 1-2 training method, a running song training method, a walk 1-2 training method, a walk song training method, a gesture groove training method, a groove sense training method, a play hard to get training method, a relax long tone training method, and an relax attack training method.

The running 1-2 training method allows for simply splitting the trainee's own groove to first and second rhythms. For example, the trainee is trained to recognize the timing of his feet in compliance with the first and second rhythms considering the speed of the treadmill as the music's BPM.

The running song training method allows for application of a groove trained through a running rhythm to speaking or singing. For example, the trainee is trained to recognize the timing of his feet as his own rhythm considering the speed of the treadmill as the music's BPM to apply it to speaking or singing.

The walk 1-2 training method allows for an effect of the treadmill to go on while the trainee walks in place in compliance with first and second rhythms through a groove trained on the treadmill. For example, the trainee is trained to recognize the timing of his feet to the first and second rhythms walking on the flat ground with a sense felt when he is on the treadmill.

The walk song training method allows for recognition of a rhythmic groove through walk by applying a sense trained trough a running rhythm to speaking or singing on the walk. For example, the trainee is trained to apply his own rhythm to speaking or singing walking on the flat ground with a sense felt when he is on the treadmill.

The gesture groove training method allows for creation of a rhythm using the timing of the trainee's hand gesture to a rhythm as if the trainee conducts. For example, the trainee is trained to recognize a gesture other than walking as rhythm timing and apply his own rhythm to speaking or singing.

The groove sense training method allows for the trainee to catch his own rhythm timing with his sense without using any body action. For example, the trainee is trained to catch timing only with his sense with any body action and apply the rhythm to speaking or singing.

The play hard to get training method allows for the trainee to express the strength and emphasis of speaking, the strength and emphasis of singing, and the accent of English and other languages by making use of his own rhythm. For example, the trainee is trained to say a particular word on speaking or the lyrics on singing long, quickly or loudly to his own rhythm.

The relax long tone training method allows for the diaphragm in charge of air pressure to catch air longer through training that enables a tone to last long. For example, the trainee is trained to say ‘ah’ as long as possible at a breath in a middle or high voice tone, while standing up with his head slightly down.

The relax attack training method allows for training the pressure of the diaphragm, increasing the elasticity of the diaphragm, and a sound from the diaphragm to come out seamlessly. For example, the trainee is trained to say ‘ah’ very shortly at a middle or high voice tone while upstanding with his head slightly down. In this case, the trainee makes the vocal sound last as long as possible at a breath.

Voice Training Area

The training method by the voice training area includes a practic tongue training method, a practic jaw training method, a practic facial muscle training method, a practic facial outside muscle training method, a head move training method, a vibration apply song training method, a natural tone training method, a practic abdomen pressure training method, a no breathing start training method, a pitch training method, a low-high pitch training method, an apple pitch training method, a schoolbook expression training method, a narration expression training method, a musical between original training method, a musical expression training method, an original expression training method, and a ah resonator training method.

The above-listed training methods are described below in greater detail.

The practic tongue training method allows for minimized involvement of a sound produced by the tongue muscle by checking the degree of involvement of the tongue muscle upon practic. For example, a first person pushes the root of the tongue of a second person with the thumb and index finger of his hand wearing a rubber glove to relax. At this time, the second person says ‘ah.’

The practic jaw training method allows for minimized involvement of a sound produced by the tongue muscle by checking the degree of involvement of the tongue muscle upon practic. For example, the first person pushes the second person's jaw with his thumb, index finger, or palm to relax. At this time, the second person says ‘ah.’

The practic facial muscle training method allows for minimized involvement of a sound produced by a facial muscle by checking the degree of involvement of the facial muscle upon practic. For example, the trainee is trained to produce a vocal sound to check on the mirror whether the facial muscle relaxes simultaneously with speaking or singing.

The practic facial outside muscle training method allows for minimized involvement of a sound produced from a muscle outside the neck by checking the degree of involvement of the muscle outside the neck upon practic. For example, the first person pushes the second person's outside-neck muscle with his thumb, index finger, or palm to relax. At this time, the second person says ‘ah.’

The head move training method allows for reduction in involvement of a sound produced by the trainee's head. For example, the second person turns his head to produce a sound, and then, the first person swiftly stimulates the muscles outside the neck to relax.

The vibration apply song training method allows for natural utilization of vibration upon singing. For example, the trainee is trained to sing a song while simultaneously saying ‘ah’ with vibration, so that the sense of vibration may be used in singing.

The natural tone apply song training method allows for natural application of a speaking tone to singing or the trainee to sing or produce a vocal sound at his normal speaking tone. For example, the trainee is trained to naturally apply his normal voice tone on the phone to singing so that he may sing at a speaking tone.

The practic abdomen pressure training method allows forr minimized involvement of a sound produced by an external abdominal muscle by checking the abdominal pressure upon practic. For example, the second person produces a sound, and then, the first person swiftly relaxes the second person's abdominal muscle using, e.g., his elbow.

The no breathing start training method allows for removal of the trainee's feeling that too much sound comes out of the abdomen, so that the diaphragm may naturally treat sound.

The pitch training method allows for removal of the prejudice that a higher voice tone is better through reconsideration of the recognition of pitch.

The low-high pitch training method allows for recognition of a number of sounds between doh and doh# in in the piano keys and the doh sound immediately before doh# to be produced so as to prevent the pitch from being lowered.

Upon singing with the larynx up, the external muscles of the vocal cords are further involved, and singing at a high voice tone with the larynx up renders it more difficult to produce a high-tone voice. Accordingly, the apple pitch training method allows for the trainee to be aware that there is no relationship between the position of larynx and the high-and-low of the pitch. For example, the trainee is trained to say at a high tone with the larynx fixed at the middle position while producing his base chest sound. At this time, the larynx needs to be not lifted up.

The schoolbook expression training method allows for the trainee to sense his vocal condition when reading a book. For example, the trainee is trained to maintain the vocal condition when reading a book.

The narration expression training method allows for the trainee to sense the vocal condition upon narration.

The musical between original training method allows for the trainee to sense the vocal condition of an expression in the musical genre that both conducts vocalization and delivers lines.

The musical expression training method allows for the trainee to sense the vocal condition that enables the most ideal delivery through the schoolbook expression training method, narration expression training method, and musical between original training method.

The original expression training method allows for the trainee to sense the vocal condition when he normally sings a song. For example, the trainee is trained to consciously maintain the vocal condition when he sings.

The ah resonator training method allows for correction of the trainee's habit that he makes only a particular pronunciation in a certain resonant space by saying ‘ah’ to create all the resonances. For example, the trainee is trained to create all the resonances.

Breathing/Vocalizing Training Area

The training method by the breathing/vocalizing training area includes an erase mimic training method, a castle gate training method, a dog breath training method, a dog breath song training method, a top of a mountain training method, a pull chest voice training method, a pull head voice training area, and a bay attack training method.

The above-listed training methods are described below in greater detail.

The erase mimic training method allows for removal of mimicking a singer's voice tone or singing style by allowing the trainee's resonant voice to be recognized and applying the resonant voice to singing. For example, the trainee is trained to recognize his resonant voice and sing at his resonant voice tone while disregarding the singer's singing style.

The castle gate training method prevents a breath from scratching the vocal cords with the vocal cords opened by making use of the sense of opening and closing the glottis by training how to close the glottis of the vocal cords. For example, the trainee is trained to produce a sound that closes the glottis by saying ‘tteh-kkih.’

The dog breath training method allows for increasing the elasticity of the diaphragm and utilization of the diaphragm rather than the abdominal muscles by making use of a breath. For example, the trainee is trained to say ‘hehe’ while stopping the breath by the diaphragm.

The dog breath song training method allows for a sound to be produced from the diaphragm by using the elasticity of the diaphragm while saying, as is, the lyrics or lines in training the dog breath training method. For example, the trainee is trained to vocalize while producing a sound with the pronunciation in the breath in the same way as he does in the dog breath training method.

The top of a mountain training method allows for the external muscles to be less strained by making use of the vocal condition as obtained when the trainee calls other person positioned far away on the top of a mountain. For example, the trainee is trained to loudly say ‘yah-hoh’ as if he sends the sound far away.

The pull chest voice training method allows for a high-tone sound and a chest sound to be produced better by making use of the elasticity of the vocal cords as if he feels the vocal cords pulled. For example, the trainee is trained to say ‘erh’ in a chest sound like he slightly pulls the larynx up.

The pull head voice training area allows for a head voice to be produced better by making use of the elasticity of the vocal cords as if the vocal cords feel pulled. For example, the trainee is trained to say “ahkkamama ahkkama” in falsetto with the larynx strained as if the larynx feels pulled.

The baby attack training method allows for the trainee to be trained for his sense by repeatedly practicing the closure of the vocal cords. For example, the trainee is trained to say “ahkkyakkyakkyak” in a chest voice as if a baby makes a sound.

According to exemplary embodiments of the present invention, a vocal practic and voice practic system allows for systematized training on each classified training area. Accordingly, the vocal practic and voice practic system may provide a uniform result to all the trainees and may apply to general vocalization as well as singing.

Each of the aforementioned components of the electronic device may include one or more parts, and a name of the part may vary with a type of the electronic device. The electronic device in accordance with various exemplary embodiments of the present disclosure may include at least one of the aforementioned components, omit some of them, or include other additional component(s). Some of the components may be combined into an entity, but the entity may perform the same functions as the components may do.

The term ‘unit,’ ‘part,’ and ‘module’ may refer to a unit including one of hardware, software, and firmware, or a combination thereof. The term ‘module’ may be interchangeably used with a unit, logic, logical block, component, or circuit. The module may be a minimum unit or part of an integrated component. The module may be a minimum unit or part of performing one or more functions. The module may be implemented mechanically or electronically. For example, the module may include at least one of Application Specific Integrated Circuit (ASIC) chips, Field Programmable Gate Arrays (FPGAs), or Programmable Logic Arrays (PLAs) that perform some operations, which have already been known or will be developed in the future.

At least a part of the system or method may be implemented as instructions stored in a computer-readable storage medium e.g., in the form of a programming module. The instructions, when executed by one or more processor, may cause the processor to carry out a corresponding function. The computer-readable storage medium may be e.g., the memory. At least a part of the programming module may include e.g., a module, program, routine, set of instructions, process, or the like for performing one or more functions.

The above-described training areas may be stored in a computer-readable storage medium in a software-like or hardware-like manner.

The computer-readable storage medium may include a hardware device configured to store and perform program instructions (e.g., programming module), such as magnetic media such as hard discs, floppy discs, and magnetic tapes, optical media such as Compact Disc ROMs (CD-ROMs) and Digital Versatile Discs (DVDs), magneto-optical media such as floptical disks, ROMs, RAMs, Flash Memories, and/or the like. Examples of the program instructions may include not only machine language codes but also high-level language codes which are executable by various computing means using an interpreter. The aforementioned hardware devices may be configured to operate as one or more software modules to carry out exemplary embodiments of the present invention, and vice versa.

Modules or programming modules in accordance with various exemplary embodiments of the present disclosure may include at least one or more of the aforementioned components, omit some of them, or further include other additional components. Operations performed by modules, programming modules or other components in accordance with various exemplary embodiments of the present invention may be carried out sequentially, simultaneously, repeatedly, or heuristically. Furthermore, some of the operations may be performed in a different order, or omitted, or include other additional operation(s).

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. A vocal practic and voice practic system, comprising:
a storage unit configured to store a reference waveform that is generated based on a trainer's period vocal sound during a predetermined sampling period;
a recording unit configured to record a trainee's period vocal sound that is generated as the trainee sings or recites during the predetermined sampling period;
a waveform converting unit configured to convert the trainee's period vocal sound into an initial period waveform;
a waveform analyzing unit configured to extract the reference waveform from the storage unit and to compare the extracted reference waveform with the initial period waveform; and
a display unit configured to display the extracted reference waveform and the initial period waveform.

2. The vocal practic and voice practic system of claim 1, wherein the recording unit is configured to record the trainee's additional vocal sound during the sampling period while an exercise on a training area prepared for the trainee is performed or at a plurality of times when the exercise is complete, the waveform converting unit is configured to convert the recorded additional vocal sound into an additional period waveform, the waveform analyzing unit is configured to compare the additional period waveform with the initial period waveform and the reference waveform, and the display unit is configured to display a result of the comparison, so that the trainee may visually recognize a degree of correction and whether the trainee's vocal is corrected.

3. The vocal practic and voice practic system of claim 1, wherein the training area includes one or more of a vocal cord vibration training area, a resonance training area, a rhythm training area, a voice training area, and a breathing/vocalizing training area.

4. The vocal practic and voice practic system of claim 2, wherein the waveform analyzing unit is configured to display through the display unit a consistency ratio for each training area when comparing the initial period waveform with the reference waveform or comparing the additional period waveform with the reference waveform.

5. The vocal practic and voice practic system of claim 3, wherein the waveform analyzing unit is configured to generate a schedule per training area depending on the consistency ratio and to display the generated schedule through the display unit.

6. The vocal practic and voice practic system of claim 2, wherein a training method by the vocal cord vibration training area includes one or more of a relax deep breath training method, an avo lips trill training method, a from vocal cords training method, an elastic utilize training method, a rebound training method, an Adam's apple training method, a grip training method, an outside muscle training method, an acceleration training method, a natural tone training method, a whisper training method, an elastic condition training method, a natural song training method, a whisper song training method, a rubber ball timing training method, and a balance togu training method.

7. The vocal practic and voice practic system of claim 2, wherein a training method by the resonance training area includes one or more of a nasal cavity low training method, a nasal cavity middle training method, a nasal cavity high training method, a natural dream training method, a NING NING training method, a nasal cavity condition training method, a natural philtrum training method, a philtrum and dream training method, a nasal cavity activation training method, a nasal cavity scale hindrance muscle training method, a pharynx scale hindrance muscle training method, a pharynx falsetto training method, a real voice and head voice training method, and a and for training method.

8. The vocal practic and voice practic system of claim 2, wherein a training method by the resonance training area includes one or more of a running 1-2 training method, a running song training method, a walk 1-2 training method, a walk song training method, a gesture groove training method, a groove sense training method, a play hard to get training method, a relax long tone training method, and an relax attack training method.

9. The vocal practic and voice practic system of claim 2, wherein a training method by the voice training area includes one or more of a practic tongue training method, a practic jaw training method, a practic facial muscle training method, a practic facial outside muscle training method, a head move training method, a vibration apply song training method, a natural tone training method, a practic abdomen pressure training method, a no breathing start training method, a pitch training method, a low-high pitch training method, an apple pitch training method, a schoolbook expression training method, a narration expression training method, a musical between original training method, a musical expression training method, an original expression training method, and a ah resonator training method.

10. The vocal practic and voice practic system of claim 2, wherein a training method by the breathing/vocalizing training area includes one or more of an erase mimic training method, a castle gate training method, a dog breath training method, a dog breath song training method, a top of a mountain training method, a pull chest voice training method, a pull head voice training area, and a baby attack training method.

11. A vocal practic and voice practic system, comprising:
a storage unit configured to store a reference waveform that is generated based on a first person's period vocal sound during a predetermined sampling period;
a recording unit configured to record a second person's period vocal sound that is generated as the second person sings or recites during the predetermined sampling period;
a waveform converting unit configured to convert the second person's period vocal sound into an initial period waveform;
a waveform analyzing unit configured to extract the reference waveform from the storage unit and to compare the extracted reference waveform with the initial period waveform; and
a display unit configured to display the extracted reference waveform and the initial period waveform, wherein the recording unit is configured to record the second person's additional vocal sound during the sampling period while an exercise on training areas prepared for the second person is performed or at a plurality of times when the exercise is complete.

12. The vocal practic and voice practic system of claim 11, wherein, the waveform converting unit is configured to convert the recorded additional vocal sound into an additional period waveform, the waveform analyzing unit is configured to compare the additional period waveform with the initial period waveform and the reference waveform, and the display unit is configured to display a result of the comparison, so that the second person may visually recognize a degree of correction and whether the second person's vocal is corrected.

13. The vocal practic and voice practic system of claim 11, wherein the training areas are stored in a memory and is processed by a computer-readable processor.

14. The vocal practic and voice practic system of claim 13, wherein the training areas include one or more of a vocal cord vibration training area, a resonance training area, a rhythm training area, a voice training area, and a breathing/vocalizing training area.

15. The vocal practic and voice practic system of claim 12, wherein the waveform analyzing unit is configured to display through the display unit a consistency ratio for each training area when comparing the initial period waveform with the reference waveform or comparing the additional period waveform with the reference waveform.

6. The vocal practic and voice practic system of claim 13, wherein the waveform analyzing unit is configured to generate a schedule per training area depending on the consistency ratio and to display the generated schedule through the display unit.

17. The vocal practic and voice practic system of claim 12, wherein a training method by the vocal cord vibration training area includes one or more of a relax deep breath training method, an avo lips trill training method, a from vocal cords training method, an elastic utilize training method, a rebound training method, an Adam's apple training method, a grip training method, an outside muscle training method, an acceleration training method, a natural tone training method, a whisper training method, an elastic condition training method, a natural song training method, a whisper song training method, a rubber ball timing training method, and a balance togu training method.

18. The vocal practic and voice practic system of claim 12, wherein a training method by the resonance training area includes one or more of a nasal cavity low training method, a nasal cavity middle training method, a nasal cavity high training method, a natural dream training method, a NING NING training method, a nasal cavity condition training method, a natural philtrum training method, a philtrum and dream training method, a nasal cavity activation training method, a nasal cavity scale hindrance muscle training method, a pharynx scale hindrance muscle training method, a pharynx falsetto training method, a real voice and head voice training method, and a and for training method.

19. The vocal practic and voice practic system of claim 12, wherein a training method by the resonance training area includes one or more of a running 1-2 training method, a running song training method, a walk 1-2 training method, as walk song training method, a gesture groove training method, a groove sense training method, a play hard to get training method, a relax long tone training method, and an relax attack training method.

20. The vocal practic and voice practic system of claim 12, wherein a training method by the voice training area includes one or more of a practic tongue training method, a practic jaw training method, a practic facial muscle training method, a practic facial outside muscle training method, a head move training method, a vibration apply song training method, a natural tone training method, a practic abdomen pressure training method, a no breathing start training method, a pitch training method, a low-high pitch training method, an apple pitch training method, a schoolbook expression training method, a narration expression training method, a musical between original training method, a musical expression training method, an original expression training method, and an ah resonator training method.
